(19) United States
(12) Patent Application Publication
(10) Pub. No.: US 2006/0051247 A1
(43) Pub. Date: Mar. 9, 2006

(54) Multi-well container processing systems, system components, and related methods

(75) Inventors: Kenneth J. Micklash II, Royal Oak, MI (US); Robert Charles Downs, La Jolla, CA (US); Jim Yuchen Chang, San Diego, CA (US); James Kevin Mainquist, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC, Hamilton (BM)

(21) Appl. No.: 11/198,918

(22) Filed: Aug. 3, 2005

Related U.S. Application Data
(60) Provisional application No. 60/598,994, filed on Aug. 4, 2004.

(51) Int. Cl. B01L 3/02

(52) U.S. Cl. 422/100

(57) ABSTRACT

The present invention provides fluid removal heads and related multi-well container processing systems for the efficient removal of fluids from multi-well containers. Methods of removing fluid from multi-well containers are also provided.

### CROSS-REFERENCES TO RELATED APPLICATIONS

This application claims the benefit of U.S. Provisional Application No. 60/598,994, filed Aug. 4, 2004, the disclosure of which is incorporated by reference in its entirety for all purposes.

### FIELD OF THE INVENTION

The present invention relates generally to the processing of multi-well containers in which materials, such as fluids or the like are removed from and/or dispensed into the wells of these containers.

### BACKGROUND OF THE INVENTION

The multi-well container has rapidly become a standard format utilized in many modern pharmaceutical discovery and development procedures, including various biochemical and cell-based assays. For example, numerous common cell-based assay steps are routinely performed in parallel in multi-well containers. These include steps such as dispensing and removing cell culture media, washing cells, dosing cells with drug candidates, incubating cell cultures, and detecting cellular responses. The advantages of these methods of screening candidates include significantly enhanced throughput relative to previous approaches. Throughput is improving even further as many of these assays are being performed in increasingly automated systems.

More specific examples of common types of assays performed in multi-well containers include those relating to signal transduction, cell adhesion, apoptosis, cell migration, GPCR, cell permeability, receptor/ligand assays, and cell growth/proliferation. Additional details relating to these and other assays involving multi-well containers are described in, e.g., Parker et al. (2000) “Development of high throughput screening assays using fluorescence polarization: nuclear receptor-ligand binding and kinase/phosphatase assays,” J. Biomolecular Screening 5(2):77-88, Asa (2001) “Automating cell permeability assays,” Screening 1:36-37, Norrington (1999) “Automation of the drug discovery process,” Innovations in Pharmaceutical Technology 1(2):34-39, Fukushima et al. (2001) “Induction of reduced endothelial permeability to horseradish peroxidase by factor(s) of human astrocytes and bladder carcinoma cells: detection in multi-well container culture,” Methods Cell Sci. 23(4):211-9, Neumayer (1998) “Fluorescence ELISA, a comparison between two fluorogenic and one chromogenic enzyme substrate,” BPI 10(Nr. 5), Graeff et al. (2002) “A novel cycling assay for nicotinic acid-adenine dinucleotide phosphate with nanomolar sensitivity,” Biochem J. 367(Pt 1): 163-8, Rogers et al. (2002) “Fluorescence detection of plant extracts that affect neuronal voltage-gated Ca²⁺ channels,” Eur. J. Pharm. Sci. 15(4):321-30, and Rappaport et al. (2002) “New perfluorocarbon system for multilayer growth of anchorage-dependent mammalian cells,” Biotechniques 32(1):142-51, which are each incorporated by reference.

Many of the protocols referred to above include steps in which materials are dispensed into and/or removed from wells disposed in the multi-well containers. To illustrate, certain cell-based ELISA assays involve removing solvents or other fluidic materials from wells in which cells remain adhered to well sides and/or bottoms. Thereafter, new fluids may be dispensed into the wells, e.g., to wash the cells or the like. Pre-existing devices used to remove these fluidic materials from the wells typically utilize syringe or vacuum pumps having tips that aspirate the fluids from the wells. These techniques, which typically involve inserting the tips into fluids disposed in the wells to effect aspiration, oftentimes necessitate washing the device tips between successive aspirations in an effort to minimize cross-contamination among wells in the multi-well container. To illustrate, one source of cross-contamination among wells can occur during these processes when fluids from one set of wells adhere to the outer surfaces of these tips and are transferred to another set of wells. The frequent tip washings associated with these approaches significantly limit assay throughput.

From the foregoing, it is apparent that additional devices, systems, and methods for removing fluids and/or other materials from multi-well containers or other multi-well containers are desirable. For example, it is desirable to remove materials from multi-well containers, inter alia, to minimize both cross-contamination among wells of these containers and the number of device washing steps performed between material removal steps. These attributes significantly improve the throughput, flexibility, and quality of assays or other procedures that involve the multi-well format relative to those performed with pre-existing devices and methods. These and a variety of additional features of the present invention will become evident upon complete review of the following disclosure.

### SUMMARY OF THE INVENTION

The present invention provides multi-well container processing systems and system components. For example, the invention provides fluid removal heads that can be used to remove fluidic materials from multi-well containers, such as micro-well plates, reaction blocks, and the like. The fluid removal heads of the invention include tips that are structured to minimize cross-contamination among wells when fluids are removed from the containers. Typically, these fluid removal heads are included as components of the systems of the invention. The systems described herein may be utilized to perform, e.g., well washing or cleaning steps, various assays, and other procedures with throughput that is superior to those processes performed using many pre-existing systems. The invention also provides methods of removing fluid from multi-well containers and kits that include the fluid removal heads described herein.

In one aspect, the invention provides a fluid removal head that includes at least one tip that comprises at least one inlet and at least one outlet, which inlet communicates with the outlet. The tip is structured such that when the tip is disposed in, or proximal to an opening to, a selected well of a multi-well container, a space disposed between an outer surface of the tip and sides of, and/or an opening to, the well forms a vent opening. When the tip is disposed in the well or proximal to the opening to well, the space disposed between the outer surface of the tip and the sides of, and/or the opening to, the well typically comprises a distance of 1 mm or less. In addition, when the tip is positioned above a surface of residual fluid disposed in the well and a selected negative pressure is applied to the tip, the applied negative pressure draws air through the vent opening resulting in removal of adherent fluid from the tip and from the sides of the well.

The fluid removal head of the invention includes various embodiments. For example, the fluid removal head typically includes at least one body structure. In some of these embodiments, a resilient coupling couples the tip to the body structure. Optionally, the body structure includes at least one manifold, e.g., fabricated within the body structure. To further illustrate, the body structure includes at least one cavity in which the tip extends 0.1 mm or more into the cavity in some of these embodiments. Optionally, the body structure includes at least one tip holder and at least one port mount that are coupled together to form the cavity. The tip holder generally holds the tip and the port mount typically includes at least one port having a channel disposed therethrough, which channel communicates with the cavity. In some embodiments, the tip and/or port mount is fabricated from an alloy or a metallic substance (e.g., stainless steel, anodized aluminium, etc.) and the tip holder is fabricated from a polymeric substance. Typically, surfaces of the cavity and the channel are substantially smooth, e.g., to minimize the risk of contaminating cell growth or other contaminating accumulation, which may otherwise occur if the surfaces included crevices or other imperfections. Further, at least one surface of the body structure that forms at least a portion of the cavity is optionally angled toward the channel, e.g., to assist the flow of removed fluids toward the channel. In certain embodiments, the fluid removal head is structured to remove fluids from a plurality of multi-well containers substantially simultaneously. Typically, the fluid removal head includes at least two tips that are spaced at a distance that substantially corresponds to a distance between at least two wells disposed in a multi-well container. In some of these embodiments, the tips are structured to remove fluids from multi-well containers that include, e.g., 6, 12, 24, 48, 96, 192, 384, 768, 1536, or more wells.

In another aspect, the invention provides a multi-well container processing system. The system includes a) at least one tip that comprises at least one inlet and at least one outlet. The inlet communicates with the outlet. The tip is structured such that when the tip is disposed in a selected well of a multi-well container, a space disposed between an outer surface of the tip and sides of, and/or an opening to, the well forms a vent opening. The system also includes b) at least one negative pressure source (e.g., a pump or the like) operably connected to the outlet of the tip. In addition, the system also includes c) at least one controller operably connected to the processing system. For example, the controller typically includes at least one computer. The controller is configured to effect i) lowering the tip to a first position in the well, which first position is below a surface of fluid in the well, while applying a first negative pressure to the tip, in which the tip is lowered at a rate that is faster than the fluid is removed from the well by the negative pressure, and/or lowering the tip to the first position in the well and then apply the first negative pressure to the tip, and ii) raising the tip to a second position in the well or proximal to the opening to the well, which second position is above the surface of residual fluid in the well. The controller is also configured to effect iii) applying a second negative pressure to the tip, which second negative pressure is greater than the first negative pressure, in which the application of the second negative pressure draws air through the vent opening resulting in removal of adherent fluid from the tip and from the sides of the well.

The tips utilized in the systems of the invention include various embodiments. In certain embodiments, for example, the inlet and the outlet communicate with each other via at least one channel disposed through the tip. The channel generally includes a cross-sectional dimension of 50 μm or more, e.g., to prevent cells and other materials in fluids from obstructing the channel when those fluids are removed from the wells of a multi-well container. When the tip is disposed in the well or proximal to the opening to the well, the space disposed between the outer surface of the tip and the sides of, and/or an opening to, the well includes a distance of 1 mm or less. Optionally, the tip includes a cross-sectional shape selected from, e.g., a regular n-sided polygon, an irregular n-sided polygon, a triangle, a square, a rectangle, a trapezoid, a circle, an oval, and the like. In some embodiments, at least one valve (e.g., a solenoid valve, etc.) fluidly communicates with the tip. The valve is generally structured to regulate pressure flow from the negative pressure source. In certain embodiments, for example, the valve is operably connected to the controller, which effects the regulation of the pressure flow.

In certain embodiments, a fluid removal head comprises the tip. In some embodiments, the fluid removal head includes at least one body structure. Optionally, a resilient coupling couples the tip to the body structure, e.g., to minimize damage to system components and multi-well containers if the tips inadvertently contact the multi-well containers during operation of the system. In certain embodiments, the body structure includes at least one manifold, e.g., such that fluids can be removed from multiple wells in a multi-well container substantially simultaneously. In some embodiments, the fluid removal head includes at least two tips that are spaced to simultaneously fit within a single well of a multi-well container, e.g., such that fluid can be removed from the well through both tips. Typically, the fluid removal head includes at least two tips that are spaced at a distance that substantially corresponds to a distance between at least two wells disposed in a multi-well container. To illustrate, the tips are optionally structured to remove fluids from multi-well containers that comprise 6, 12, 24, 48, 96, 192, 384, 768, 1536, or more wells. In some embodiments, the tip extends 0.1 mm or more into a cavity of a fluid removal head body structure, e.g., to prevent removed fluid from moving from the cavity back into the tip through the outlet. Optionally, the fluid removal head is structured to remove fluids from a plurality of multi-well containers substantially simultaneously.

Typically, at least one tube operably connects the negative pressure source to the outlet. In some embodiments, the negative pressure source includes at least one manifold, e.g., such that the negative pressure source can apply negative pressure in multiple operably connected tubes. The negative pressure source is generally configured to apply the first negative pressure at at least 28.5 inches Hg at a flow rate of at least 0.1 cubic feet per minute at each inlet. In addition, the negative pressure source is also generally configured to apply the second negative pressure at a flow rate at each inlet that is at least 5 times more than the flow rate of the first negative pressure at each inlet.

The multi-well container processing system of the invention also optionally includes one or more other components. In some embodiments, for example, the system includes at least one trap that is operably connected to the tip. The trap is generally structured to trap waste fluid that is removed from wells of a multi-well container. In certain embodiments, the system includes at least one robotic gripping component that is structured to grip and translocate multi-well containers between components of the multi-well container processing system and/or between the multi-well container processing system and another location. Optionally, the system includes at least one multi-well container storage component that is structured to store one or more multi-well containers. In some embodiments, the system includes at least one incubation component that is structured to incubate one or more multi-well containers. In certain embodiments, the system includes at least one detection component that is structured to detect detectable signals produced in one or more wells disposed in one or more multi-well containers. In some embodiments, the system includes at least one positioning component that is structured to position one or more multi-well containers relative to the tip. Optionally, the system includes at least one translocation component that is structured to translocate the tip and/or at least one other system component relative to one another. In certain embodiments, the system includes at least one cleaning component that is structured to clean the tip and/or at least one other system component.

To further illustrate, the system includes at least one dispensing component that is structured to dispense one or more fluids into one or more wells of one or more multi-well containers in some embodiments of the invention. In these embodiments, the dispensing component typically includes at least one dispenser that aligns with one or more wells disposed in one or more multi-well containers when the multi-well containers are disposed proximal to the dispenser. The dispenser is generally structured to dispense one or more fluids into the wells. In some embodiments, the dispenser is angled relative to a vertical axis of the wells, e.g., such that when fluids are dispensed from the dispenser they contact the sides of wells instead of directly contacting cells adhered at the bottoms of wells to minimize disruption of the cells. In some of these embodiments, the dispensing component is structured to dispense the fluids into a plurality of multi-well containers substantially simultaneously.

In still another aspect, the invention relates to a method of removing fluid from a well of multi-well container. The method includes a) providing at least one tip that comprises at least one inlet and at least one outlet, which inlet communicates with the outlet, in which the tip has a cross-sectional dimension that is smaller that a cross-sectional dimension of the well thereby forming a vent opening in a space disposed between the tip and sides of, and/or an opening to, the well when the tip is positioned in the well or proximal to the opening to the well. The method also includes b) lowering the tip to a first position in the well, which first position is below a surface of the fluid, while applying a first negative pressure to the tip, in which the tip is lowered at a rate that is faster than the fluid is removed from the well by the negative pressure, or lowering the tip to the first position in the well and then applying the first negative pressure to the tip. In certain embodiments, the first negative pressure includes a flow rate of 0.1 or more cubic feet per minute at the inlet. The method also includes c) raising the tip to a second position in the well or proximal to the opening to the well, which second position is above the surface of residual fluid in the well. In addition, the method also includes d) applying a second negative pressure to the tip, which second negative pressure is greater than the first negative pressure, in which the application of the second negative pressure draws air through the vent opening resulting in removal of adherent fluid from an outer surface of the tip and from the sides of the well. In some embodiments, the second negative pressure includes a flow rate of 0.5 or more cubic feet per minute at the inlet. Optionally, the second negative pressure includes a flow rate at the inlet that is at least 5 times more than the flow rate of the first negative pressure at the inlet. Optionally, the method includes repeating b)-d) in at least one other well of the multi-well container. In certain embodiments, the method includes dispensing at least one additional fluid (e.g., a cleaning solvent, etc.) into the well. In these embodiments, the additional fluid optionally contacts a side of the well before contacting a bottom surface of the well or other materials disposed in the well to minimize agitation of the other materials by the additional fluid dispensed into the first well.

### BRIEF DESCRIPTION OF THE DRAWINGS

FIG. 1A schematically shows a bottom perspective view of a fluid removal head according to one embodiment of the invention.

FIG. 1B schematically depicts a side cross-sectional view through the fluid removal head of FIG. 1A.

FIG. 1C schematically shows a transparent front view of a segment of the fluid removal head of FIG. 1A.

FIG. 1D schematically illustrate a tip from the fluid removal head of FIG. 1A disposed in a well of a multi-well container from a top perspective view.

FIG. 1E schematically depicts a tip from the fluid removal head of FIG. 1A disposed in a well of a multi-well container from a cross-sectional view.

FIG. 1F schematically shows a fluid removal head from a top perspective view according to one embodiment of the invention.

FIG. 1G schematically illustrates a tip holder of the fluid removal head of FIG. 1F from a top perspective view.

FIG. 1H schematically illustrates a port mount of the fluid removal head of FIG. 1F from a top perspective view.

FIG. 2A schematically illustrates one embodiment of a multi-well container processing system from a perspective view.

FIG. 2B schematically depicts a detailed top perspective view of the fluid removal head and a dispense head from the system of FIG. 2A.

FIG. 2C schematically shows a detailed bottom perspective view of the fluid removal head and a dispense head from the system of FIG. 2A.

FIG. 3 schematically illustrates another embodiment of a multi-well container processing system from a perspective view.

FIG. 4 schematically illustrates a representative example system for removing fluids from multi-well containers in which various aspects of the present invention may be embodied.

FIG. 5 is a flowchart showing a method of removing fluid from a multi-well container according to one embodiment of the invention.

FIGS. 6A-D schematically illustrate various aspects of certain methods of removing fluid from a multi-well container according to some embodiments of the invention.

### DETAILED DESCRIPTION

I. Definitions

Before describing the present invention in detail, it is to be understood that this invention is not limited to particular embodiments. It is also to be understood that the terminology used herein is for the purpose of describing particular embodiments only, and is not intended to be limiting. Units, prefixes, and symbols are denoted in the forms suggested by the International System of Units (SI), unless specified otherwise. Numeric ranges are inclusive of the numbers defining the range. Further, unless defined otherwise, all technical and scientific terms used herein have the same meaning as commonly understood by one of ordinary skill in the art to which the invention pertains. The terms defined below, and grammatical variants thereof, are more fully defined by reference to the specification in its entirety.

The term “bottom” refers to the lowest point, level, surface, or part of a device or system, or device or system component, when oriented for typical designed or intended operational use.

A fluid removal head tip inlet “communicates” with an outlet of the tip when fluid can be translocated, e.g., from the inlet to the outlet through the tip, e.g., under an applied pressure.

The term “correspond” in the context of elements or components of a device or system refers to elements or components that are structured to function together with one another. In certain embodiments, for example, fluid removal heads include multiple tips that are spaced from one another at distances that correspond to distances between wells disposed in multi-well containers such that fluids can be removed from those wells at the same time through the tips of the fluid removal heads.

A tip is disposed “proximal to an opening to” a well of a multi-well container when a bottom end of the tip that comprises the inlet contacts a plane that includes the opening to the well or is above that plane at a distance that permits a vent opening to be formed between the tip and the opening (e.g., an edge of the opening) to the well.

The term “top” refers to the highest point, level, surface, or part of a device or system, or device or system component, when oriented for typical designed or intended operational use, such as positioning object storage modules, storing objects, and/or the like.

II. Fluid Removal Heads

While the present invention will be described with reference to a few specific embodiments, the description is illustrative of the invention and is not to be construed as limiting the invention. Various modifications can be made to the embodiments of the invention described herein by those skilled in the art without departing from the true scope of the invention as defined by the appended claims. It is also noted here that for a better understanding, certain like components are designated by like reference letters and/or numerals throughout the various figures.

In overview, the fluid removal heads of the invention may be used essentially any time fluids or other materials are to be reliably removed from the wells of multi-well containers. These devices avoid many of the problems associated with pre-existing devices, including cross-contamination among wells. Fluids can be removed from many wells of multi-well containers before the tips of fluid removal heads are washed, since adherent fluids are typically removed from the tips before removing fluids from subsequent sets of wells. This significantly decreases the cycle time for removing fluids from a multi-well container relative to cycle times achievable with pre-existing devices, especially as most pre-existing devices are washed numerous times during each cycle.

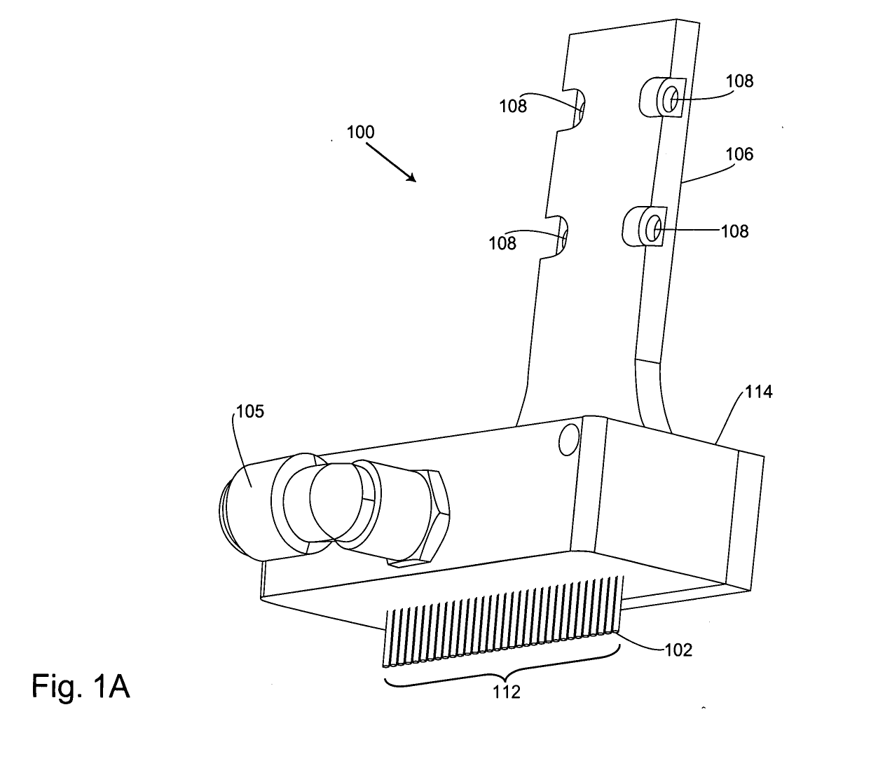

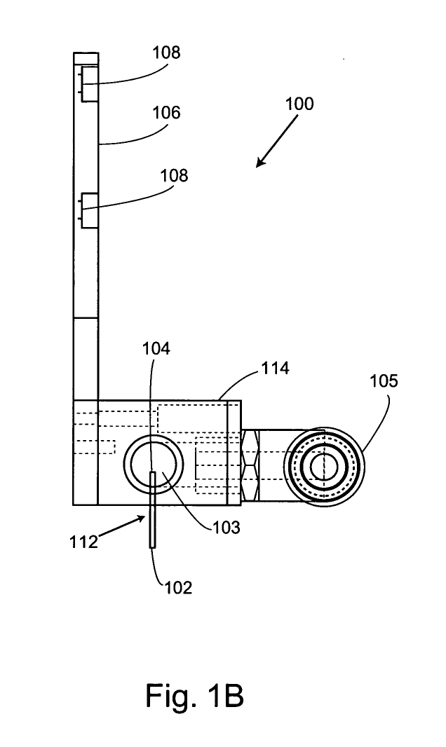

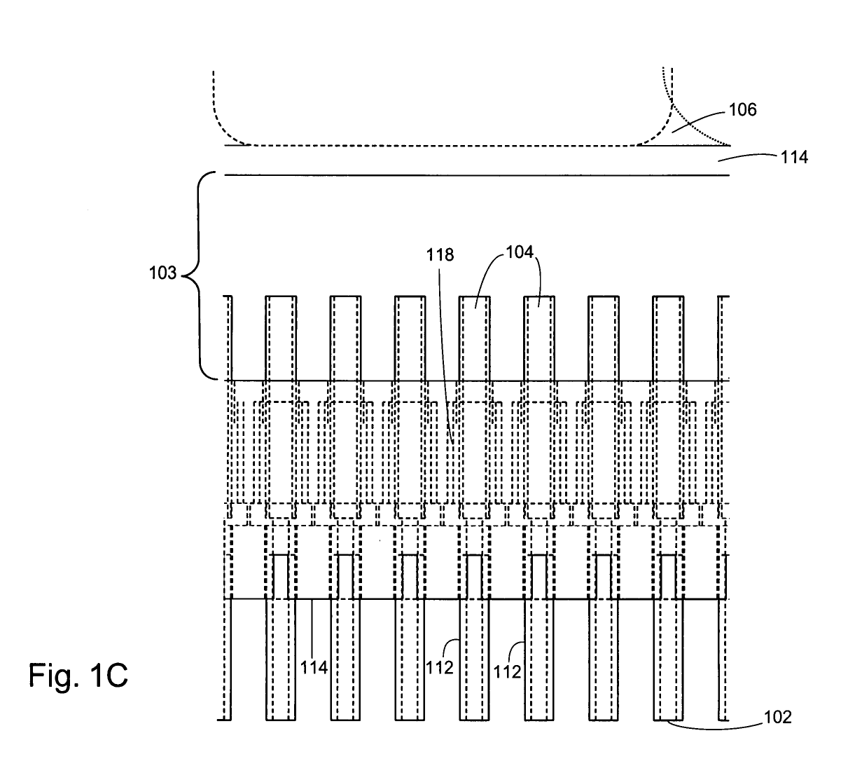

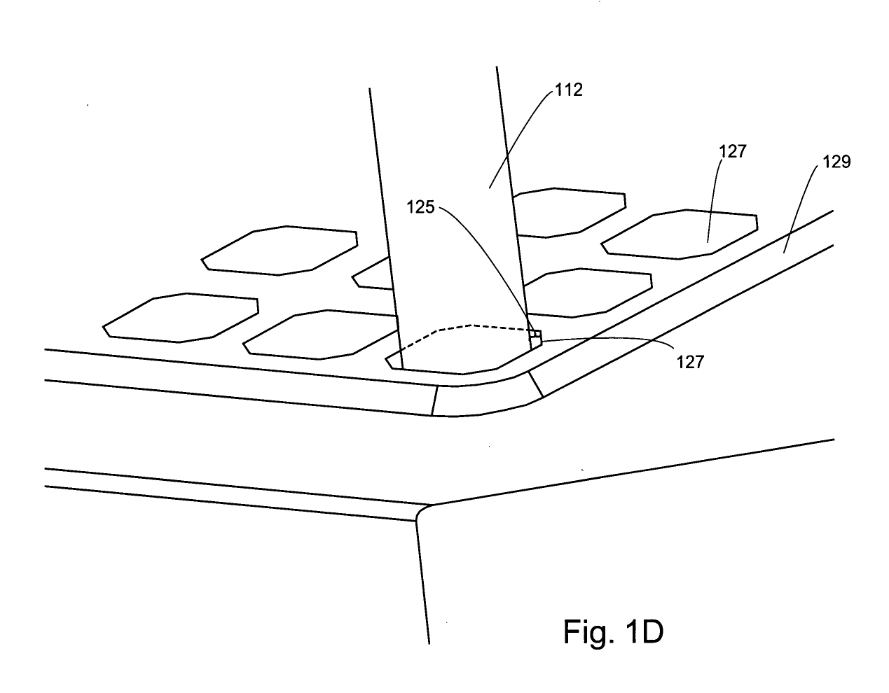

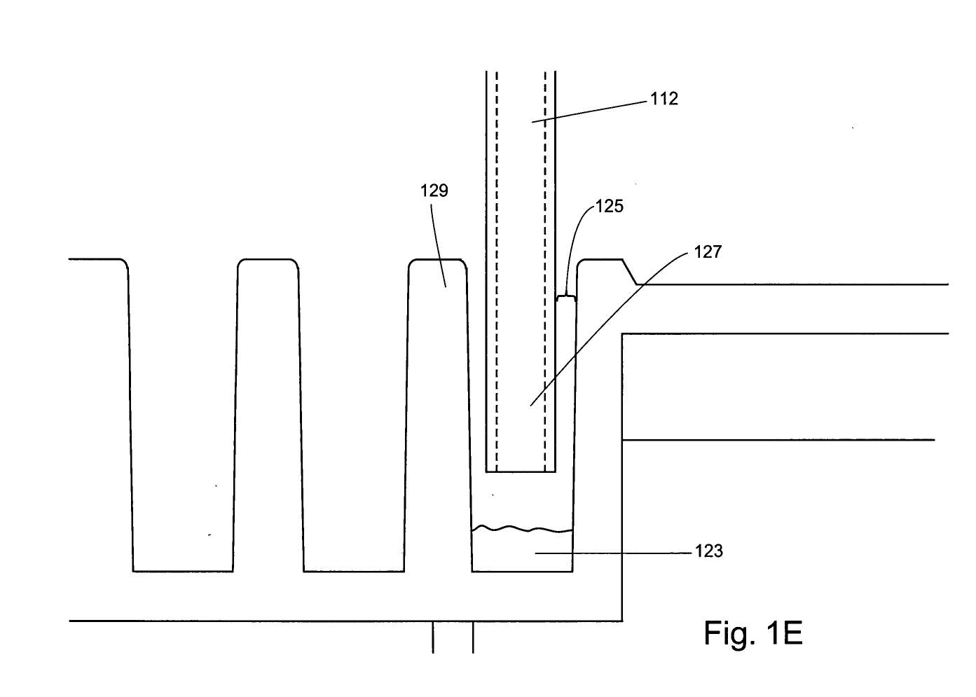

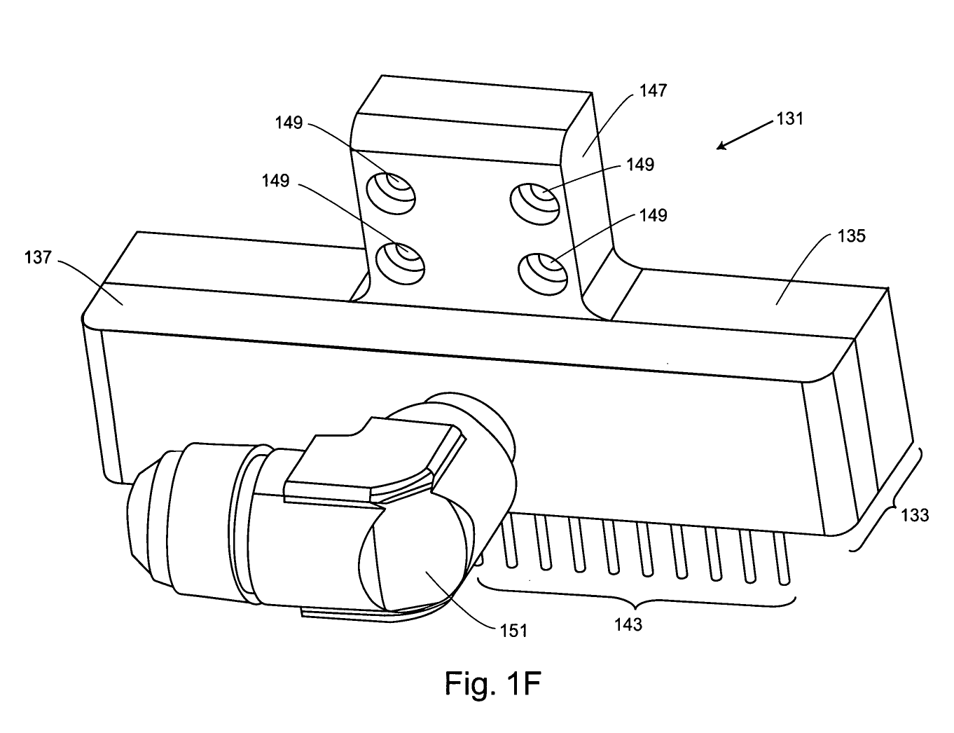

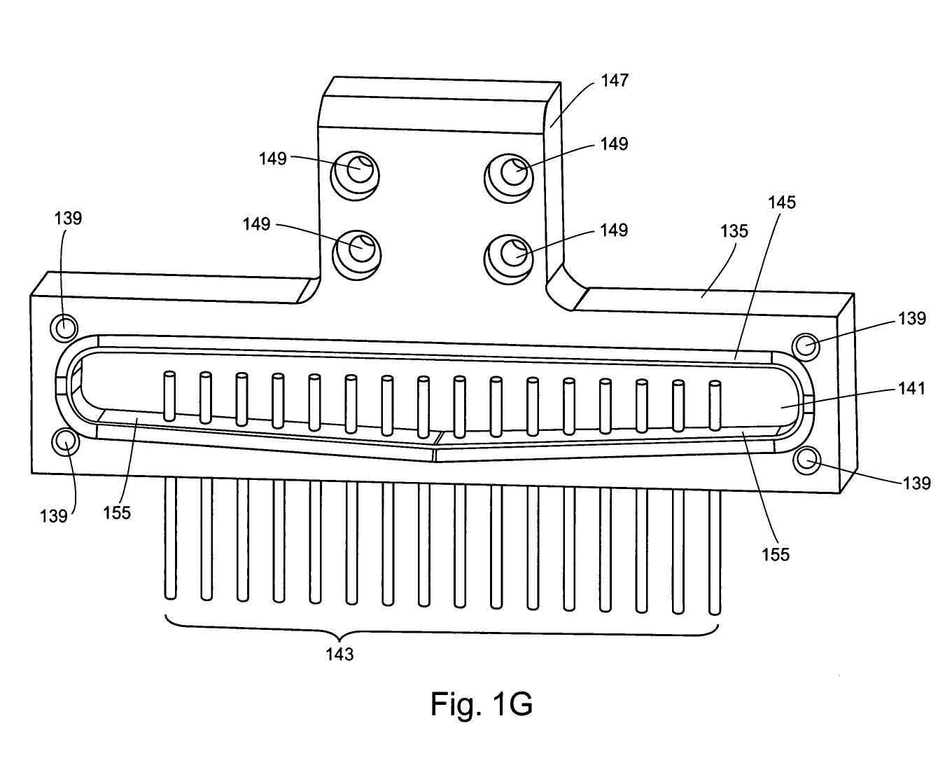

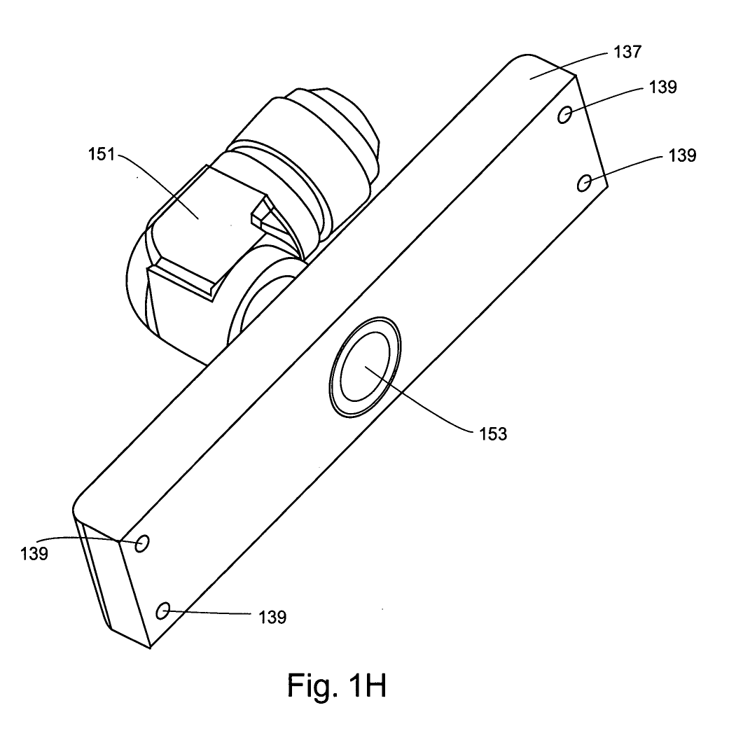

Referring initially to FIGS. 1A and B, which schematically illustrate an embodiment of a fluid removal head of the present invention from various views. More specifically, FIG. 1A schematically shows a bottom perspective view of fluid removal head 100 according to one embodiment of the invention, while FIG. 1B schematically depicts a side cross-sectional view through fluid removal head 100 from a bottom perspective view. As shown, fluid removal head 100 includes tips 112, each of which tips includes an inlet 102 that communicates with an outlet 104. In the embodiment shown, each inlet 102 communicates with a separate outlet 104. Optionally, the fluid removal heads of the invention are fabricated such that multiple inlets communicate with the same outlet. That is, fluid removal heads are optionally fabricated to comprise one or more manifolds. Tips 112 of fluid removal head 100 are structured to remove fluids from wells disposed in multi-well containers when outlets 104 are operably connected via cavity 103 and port 105 (e.g., via flexible tubes or other conduits) to one or more negative pressure sources (not shown). As also shown, tips 112, cavity 103, and port 105 together form a manifold such that fluids drawn into inlets 102 of tips 112 are directed towards port 105. In addition, tips 112 extend into cavity 103 of body structure 114, e.g., to prevent removed fluid from moving from cavity 103 back into tip 112 through outlets 104. In these embodiments, the tips typically extend about 0.1 mm or more into these cavities, and more typically about 1 mm or more (e.g., about 2 mm, about 3 mm, about 4 mm, about 5 mm, or more).

As further shown in FIGS. 1A and B, fluid removal head 100 also includes mounting bracket 106, which includes holes 108 through which screws, bolts, rivets, or other fastening devices are inserted to attach fluid removal head 100 to another device or system component, such as a translation arm or the like that moves fluid removal head 100 relative to multi-well containers, fluid removal head washing components, etc. Other methods of attaching fluid removal heads to other device or system components (e.g., adhering, bonding, welding, clamping, etc.) are referred to herein or are otherwise known in the art. In some embodiments, fluid removal heads are fabricated integral with other system components. Systems are described in greater detail below.

In the embodiment schematically depicted in FIGS. 1A and B, tips 112 of fluid removal head 100 extend from body structure 114 of fluid removal head 100. Tips 112 are typically vacuum tips or the like having channels or other cavities disposed therethrough. Optionally, the tips are fabricated as integral components of fluid removal heads (e.g., as a single molded part, etc.) or as separate components of fluid removal head, which are positioned in a separately fabricated body structure of fluid removal head during device assembly. Fabrication techniques are described further below. As shown, tips 112 are schematically illustrated as separate components.

In some embodiments, tips are resiliently coupled to body structures by resilient couplings having selected flexures or tensions, e.g., to account for well-to-well and container-to-container variations and to prevent the tips and/or multi-well containers from being damaged when they are contacted during fluid removal processes. Essentially any type of resilient coupling can be adapted for use in these embodiments. Exemplary resilient couplings include springs, elastomeric materials and other compressible solids and/or fluids. To further illustrate, FIG. 1C schematically shows a transparent front view of a segment of fluid removal head 100 in which tips 112 are resiliently coupled to body structure 114 by resilient couplings 118. In certain embodiments, resilient couplings 118 are not included in fluid removal head 100. In these embodiments, for example, resiliency is optionally designed into other device or system components to which fluid removal head 100 is attached and/or into multi-well container positioning components.

As further shown in FIGS. 1D and E, vent opening 125 is formed in a space disposed between an outer surface of tip 112 and the sides of well 127 of multi-well container 129 when tip 112 is disposed in, or proximal to an opening to, well 127. During operation, when a negative pressure source is applied to outlet 104 of tip 112 positioned above a surface of residual fluid 123 disposed in well 127, air flows through vent opening 125 into inlet 102, thereby removing adherent fluid from outer surface of tip 112 and from the sides of well 127. This prevents cross contamination from occurring among the wells of the multi-well container being processed. Tips are typically designed so that the spaces that form vent openings include distances of about 1 mm or less (e.g., about 0.9 mm, about 0.8 mm, about 0.7 mm, about 0.6 mm, about 0.5 mm, about 0.4 mm, about 0.3 mm, about 0.2 mm, about 0.1 mm, etc.).

Another exemplary fluid removal head embodiment is schematically shown in FIGS. 1F-H. As shown, fluid removal head 131 comprises body structure 133, which includes tip holder 135 and fitting or port mount 137. Tip holder 135 and fitting or port mount 137 are typically coupled together using fastening devices (not shown), such as screws, bolts, rivets, etc. that are inserted through or into holes 139. Optionally, tip holders and port mounts are coupled together using another fastening mechanism or device, including bonding, welding, clamping, or the like.

As shown in FIG. 1G, tip holder 135 of fluid removal head 131 includes a portion of cavity 141 into which tips 143 extend (e.g., about 0.1 mm or more). As described above, tips generally extend into fluid removal head cavities to prevent fluids from flowing back through the tips once vacuums or other negative pressure sources are turned off. Gasket 145 (shown as an o-ring) is typically disposed between tip holder 135 and port mount 137 to form a face seal between those components of body structure 133 (e.g., to prevent fluid leakage, etc.). As also shown, tip holder 135 includes mounting bracket 147 that includes holes 149 through which screws, bolts, rivets, or other fastening devices are inserted to attach fluid removal head 131 to another device or system component.

FIG. 1H schematically depicts port mount 137 of fluid removal head 131 from a top perspective view. As shown, port mount 137 includes port 151 through which channel 153 is disposed. Port 151 is generally operably connected (e.g., via flexible tubes or other conduits) to one or more negative pressure sources (not shown). As also shown in FIG. 1G, surfaces 155, which form a portion of cavity 141, are angled or tapered such that when fluids are removed during operation, those fluids flow toward channel 153 of port 151.

In some embodiments, the tips are fabricated from alloys or other metallic substances (e.g., stainless steel, etc.), while tip holders are fabricated from polymeric substances. In certain embodiments, for example, tips or pins are press fit into place in tip holders in the absence of glue or other adhesives, which may deteriorate over time (e.g., as they come into contact with caustic chemicals or the like). In these embodiments, tips can typically be press fit into the tip holders without being bent or otherwise deformed, since the selected polymeric tip holders generally “give” or are more resilient than the tips. Deformed tips (e.g., with varied inner diameters near bends, etc.) can lead to varying flow rates across fluid removal heads, which in turn may lead to non-uniform fluid removal from the wells of a given multi-well container.

Port mounts are also optionally fabricated from an alloy or a metallic substance. In some embodiments, for example, ports are welded into place on port mounts. In these embodiments, welds are typically placed on an interior seam to create a crevice-free joint between ports and port mounts. Crevices tend to collect some of the fluids removed from multi-well containers. These collected fluids may become sites for contaminating growth. Accordingly, other surface areas (e.g., of cavities, channels, etc.) along the fluid flow paths of the devices described herein are generally fabricated to be substantially smooth to avoid crevices or other imperfections. Device fabrication is described further below.

Tips are optionally fabricated to fit within with any well shape. For example, a tip of a fluid removal head optionally includes a cross-sectional shape selected from, e.g., a regular n-sided polygon, an irregular n-sided polygon, a triangle, a square, a rectangle, a trapezoid, a circle, an oval, etc. The inlet and outlet of a tip typically communicate with one another via at least one channel disposed through the tip. Cross-sectional dimensions of these channels typically depend on the size of the well into which the tips are to be inserted. In some embodiments, channels include cross-section dimensions of about 50 μm or more (e.g., about 100 μm, about 500 μm, about 1 mm, etc.). Tip channels can also include essentially any cross-sectional shape, such as regular n-sided polygons, irregular n-sided polygons, triangles, squares, rectangles, trapezoids, circles, ovals, and the like. In addition, tips are optionally designed to extend any distance into multi-well container wells upon being lowered into the wells depending on the well depths of the particular multi-well container (e.g., standard microtiter plates, deep well plates, reaction blocks, etc.) to be utilized. Although other tip lengths are optionally utilized, tips are typically designed to extend to within about 0.001 mm or more from the bottom of wells in a given multi-well container upon being fully inserted into the wells, e.g., so that substantially all of the fluids can be removed from the wells.

The arrangement of tips in fluid removal heads includes various embodiments. In some embodiments, fluid removal heads include multiple tips, e.g., to increase the throughput of fluid removal processes relative to those performed with devices having only single tips. In FIG. 1A, for example, fluid removal head 100 includes 32 tips 112 that are spaced at distances from one another so as to simultaneously remove fluid from, e.g., every well in a 32-well row of a 1536-well plate.

In one illustrative embodiment, removal of fluid from a 1536-well plate using this particular embodiment of fluid removal head involves placing the fluid removal head such that the tips contact the contents of every well in the first row. A vacuum is applied to the outlets, thereby drawing fluids into the inlets and removing selected volumes of fluid from the wells. The tips are then raised to another position within the wells, or proximal to openings to the wells, above the surfaces of residual fluids, if any, in the wells. A vacuum is again applied to the outlets to draw air through the vent openings such that fluids adhered to the outer surfaces of the tips and to the sides of the wells are removed. The vacuum applied to remove adherent fluids typically has a higher flow rate that the vacuum applied to remove the selected volumes of the fluids from the wells. The fluid removal head or the plate is then moved such that the tips contact the contents of every well in the second row of wells. Again, a vacuum is applied to the outlets to remove selected volumes of fluid from the second row of wells and the tips are then raised so that adherent fluids can be removed under another applied vacuum. This process is repeated as required until fluid is removed from all desired wells. Cross-contamination of wells is greatly reduced or eliminated in this process because of the removal of adherent fluid from the tips before each step of removing selected volumes of fluid from the successive rows of wells.

The tips of fluid removal heads are optionally configured to remove fluid from containers having different numbers of wells than 1536-well containers (e.g., 6, 12, 24, 48, 96, 192, 384, 768, or more well containers). Further, they can be configured to simultaneously remove fluid from any number of wells in those plates (e.g., every well in a given row or column, wells in multiple rows or columns, every well of the particular plate, etc.). To further illustrate, fluid removal heads generally include at least two tips that are spaced at a distance that substantially corresponds to a distance between at least two wells disposed in a multi-well container. For example, fluid removal heads typically include a plurality of tips in which centers of at least two of the inlets to the tips are spaced 18 mm, 9 mm, 4.5 mm, 2.25 mm, or less apart from one another so that they correspond to the center-to-center spacing between adjacent wells in, e.g., 24-, 96-, 384-, or 1536-well micro-well plates, respectively. As mentioned, other lower or higher density configurations are also optionally utilized. For example, the inlets to tips can be spaced such that they correspond to the center-to-center spacing between every other well, or every third or fourth well, in a row or column of wells. Moreover, fluid removal heads optionally include a plurality of tips at least a subset of which include a footprint that substantially corresponds to a footprint of at least a subset of at least one line of wells disposed in a multi-well container. A fluid removal head for use with a 1536-well plate, for example, can include 16 inlets having a center-to-center spacing equal to the spacing between every other well in a 32-well row of a 1536-well container, or as referred to above, include 32 inlets having a center-to-center spacing equal to the spacing between every well in a 32-well row of a 1536-well container. In these embodiments, the number of spacing regions disposed between adjacent inlets in a line of inlets is typically a multiple of the number of spacing regions disposed between adjacent wells in a corresponding line of wells disposed in the multi-well container. In certain embodiments, fluid removal heads are structured to remove fluids from a plurality of multi-well containers substantially simultaneously. To illustrate, the tips of a fluid removal head optionally include a footprint that corresponds to the footprint of at least a subset of wells disposed in multiple multi-well containers, e.g., when those containers are positioned next to one another. Optionally, the tips of fluid removal heads can be spaced such that multiple tips can be simultaneously disposed into a selected well of a given multi-well container. In some embodiments, for example, a fluid removal head having 32 tips with inlets spaced for the simultaneous removal of fluids from every well in a 32-well row of a 1536-well container can also be used, e.g., to remove fluids from a 384-well container by inserting two tips into each well of a 16-well row of the 384-well container, to remove fluids from a 96-well container by inserting four tips into each well of an 8-well row of the 96-well container, etc. This can provide an option to use a single fluid removal head with multiple multi-well container formats, which can further enhance the throughput of an application that involves more than one multi-well container format, e.g., by reducing the maintenance time that would otherwise be needed to interchange different fluid removal heads.

The external dimensions of fluid removal heads are optionally varied. In certain embodiments, for example, at least portions of fluid removal heads (e.g., surfaces that include tips) have footprints that substantially correspond to a footprint of a multi-well container or a portion of such a container. Optionally, fluid removal heads include footprints that substantially correspond to a footprint formed by multiple multi-well containers or selected portions of such containers taken together.

Fluid removal head components and other components of the devices and systems described herein are fabricated from materials or substrates that are generally selected according to properties, such as reaction inertness, durability, expense, or the like. In certain embodiments, for example, fluid removal head components are fabricated from various polymeric materials such as, polyetheretherketone (PEEK™), polytetrafluoroethylene (TEFLON™), polypropylene, polystyrene, polysulfone, polyethylene, polymethylpentene, polydimethylsiloxane (PDMS), polycarbonate, polyvinylchloride (PVC), polymethylmethacrylate (PMMA), or the like. Polymeric parts are typically economical to fabricate, which affords fluid removal head or component disposability (i.e., replacing the fluid removal head or component without replacing other device or system components, such as multi-well container storage components, washing components, etc.). Fluid removal heads or component parts are also optionally fabricated from other materials including, e.g., glass, metal (e.g., stainless steel, anodized aluminum, etc.), silicon, or the like. For example, fluid removal heads are optionally assembled from a combination of materials permanently or removably joined or fitted together, e.g., polymer or glass top body structures with stainless steel tips, etc.

The fluid removal heads or components are optionally formed by various fabrication techniques or combinations of such techniques including, e.g., injection molding, cast molding, machining, embossing, extrusion, etching, or other techniques. These and other suitable fabrication techniques are generally known in the art and described in, e.g., Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000). After fluid removal head or component part fabrication, the heads or components thereof, such as body structures, tips, cavities, etc., are optionally further processed, e.g., by coating surfaces with, e.g., a hydrophilic coating, a hydrophobic coating, or the like.

III. Multi-Well Container Processing Systems

The invention also provides multi-well container processing systems that can rapidly remove fluids from selected wells of micro-well containers, e.g., as part of a high-throughput screening or washing procedure. These systems, which are typically highly automated, include at least one fluid removal component that includes at least one negative pressure source, such as a vacuum pump, centrifugal blower, or the like in addition to at least one fluid removal head as described herein. Negative pressure sources are typically operably connected to fluid removal heads via tubes or other conduits such that negative pressure can be applied at inlets to tips of the fluid removal heads by the negative pressure source to effect fluid removal from multi-well containers. Fluid removal heads that are optionally utilized in the systems of the invention are described in greater detail above. Multi-well container processing systems also typically include positioning components, dispensing components, or both positioning and dispensing components. Positioning components are structured to position one or more multi-well containers relative to the fluid removal component, whereas dispensing components are structured to dispense materials (e.g., fluidic materials, etc.) into selected wells of multi-well containers. For example, dispensing components typically include at least one dispenser that aligns with wells disposed in one or more multi-well containers when the multi-well containers are disposed proximal to the dispenser. Controllers are also generally operably connected to one or more system components. Various other components are also optionally included in the systems of the present invention. Certain of these are described further below.

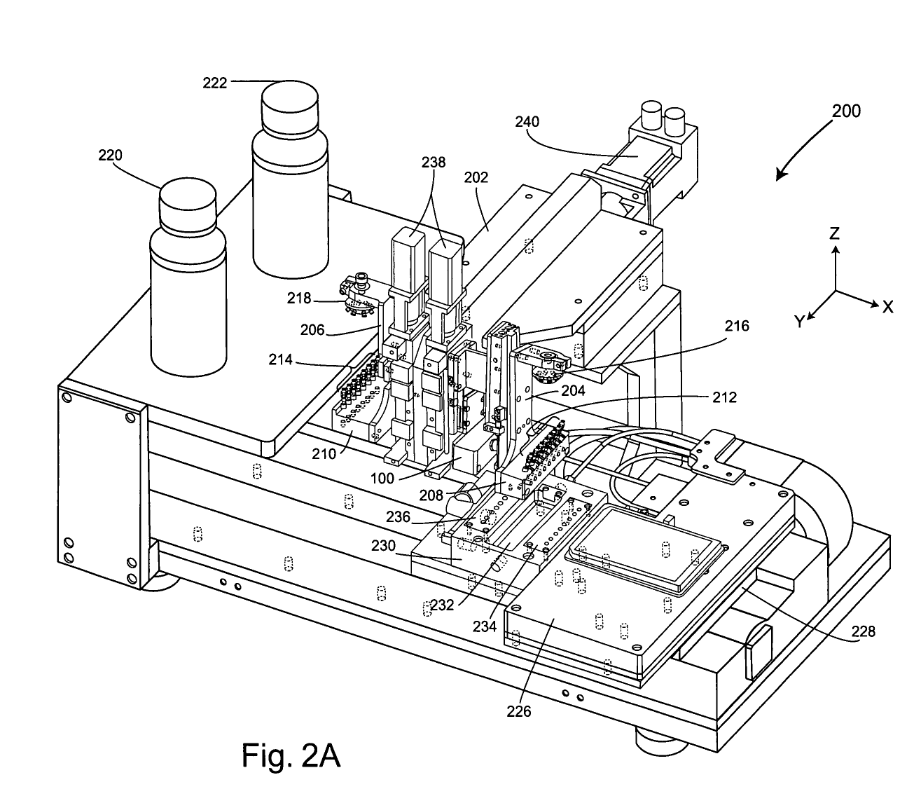

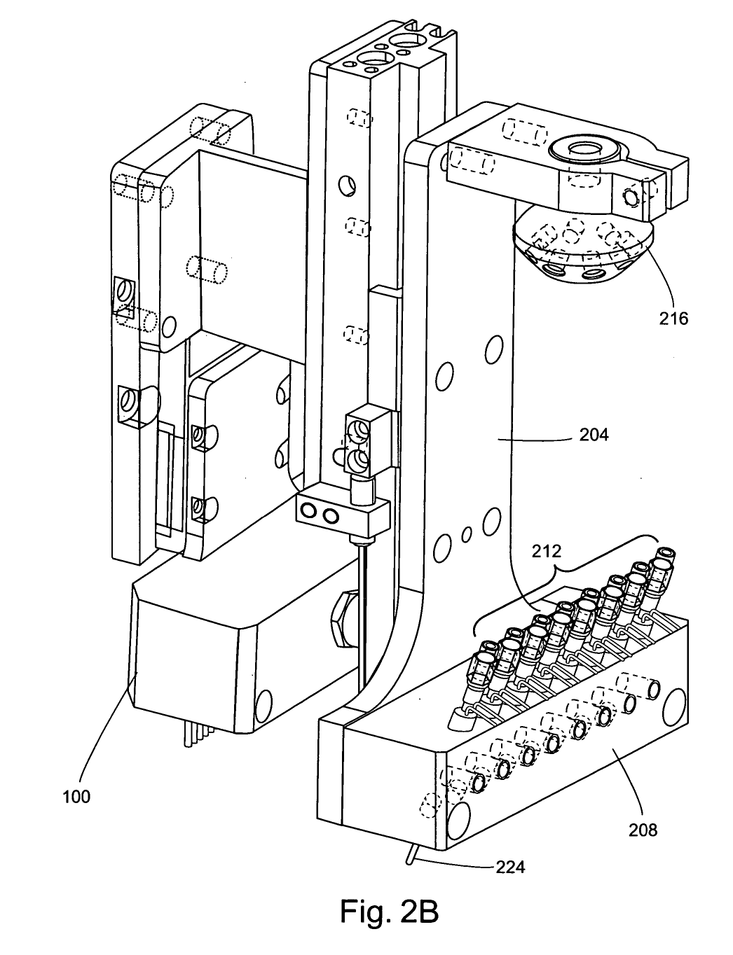

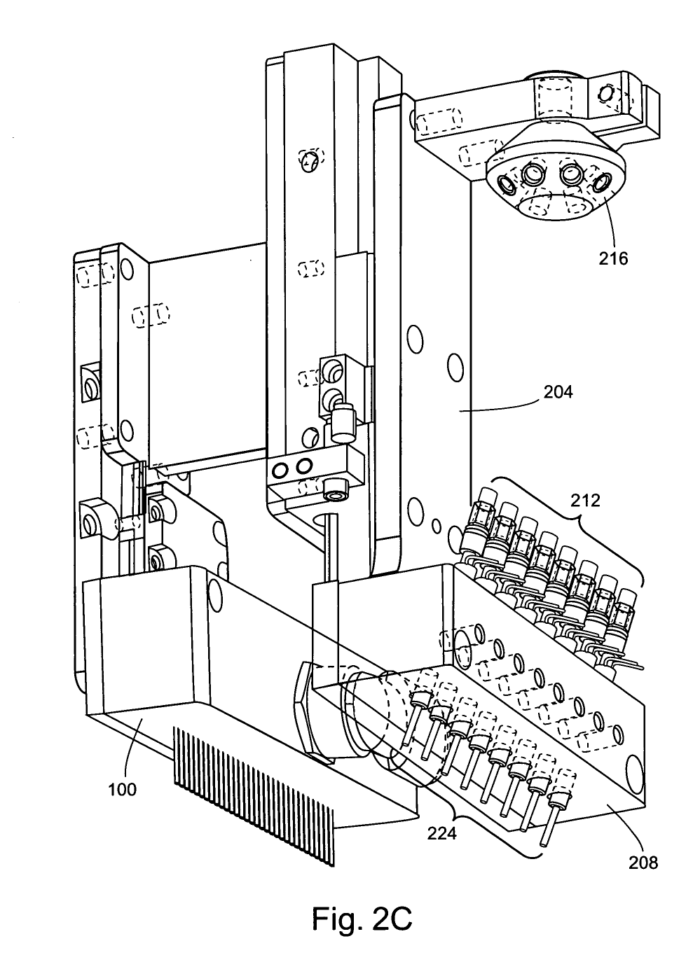

To further illustrate the systems of the invention, FIG. 2A schematically illustrates one embodiment of a multi-well container processing system from a perspective view. As shown, multi-well container processing system 200 includes fluid removal head 100 mounted on Y- and Z-axis translocation component 202. Translocation component 202 is structured to translocate fluid removal head 100 and/or other components such as dispensing components (described further below) along the Z-axis, e.g., to access a multi-well container for fluid removal. Translocation component 202 is also structured to translocate these components along the Y-axis, e.g., to move fluid removal head 100 and dispensing components across a multi-well container. More specifically, drive mechanisms 238 effect Z-axis translation, whereas drive mechanism 240 effects Y-axis movement of these components. Drive mechanism 238 and 240 are typically servo motors, stepper motors, or the like. Although not shown in FIG. 2A, a tube or other conduit operably connects fluid removal head 100 to a negative pressure source. Essentially any negative pressure source is optionally utilized in these systems to effect fluid removal as described herein. In some embodiments, for example, negative pressure sources include pumps, such as vacuum or centrifugal blower pumps that can create suction forces. Many different pumps of this nature are known in the art and are commercially available from various suppliers. Negative pressure sources are generally configured (e.g., controller directed) to apply negative pressure at various rates. In certain embodiments, a negative pressure source applies a first negative pressure at at least 28.5 inches Hg at a flow rate of at least 0.1 cubic feet per minute at each tip inlet to remove selected volumes of fluid from the wells of multi-well containers. In these embodiments, the negative pressure source is also generally configured to apply a second negative pressure at a flow rate at each tip inlet that is at least 5 times more than the flow rate of the first negative pressure at each tip inlet, e.g., to effect removal of adherent fluids from tip surfaces and from the sides of wells as described herein. At least one valve (e.g., a solenoid valve, etc.) that is structured to regulate pressure flow from the negative pressure source is generally operably connected to fluid removal head 100 and/or the tube. In addition, one or more traps (e.g., fluid traps, containers, filters, etc.) are typically disposed in the fluid line between fluid removal head 100 and the negative pressure source to trap and store materials (e.g., waste materials or the like) removed from multi-well containers for subsequent disposal.

As also shown, multi-well container processing system 200 further includes dispensing components 204 and 206 mounted on translocation component 202. Translocation component 202 also translates or moves dispensing components 204 and 206 along the Y and Z axes. Dispensing components 204 and 206 include dispense heads 208 and 210. Although not shown, tubes or other fluid conduits typically fluidly connect solenoid valves 212 and 214 to manifolds 216 and 218, respectively. The dispensing components of the invention optionally include peristaltic pumps, syringe pumps, bottle valves, etc. Manifolds 216 and 218 are also typically in fluid communication with one or more containers (e.g., fluid containers 220 and 222) via tubes or other fluid conduits (not shown). Fluid is generally conveyed from these containers to dispense heads 208 and 210 by operably connected fluid direction components, such as pumps or the like.

FIGS. 2B and C schematically depict a detailed top and bottom perspective view, respectively, of fluid removal head 100 and dispense head 208 from multi-well container processing system 200 of FIG. 2A. In the embodiment shown, dispensers or dispense tips 224 are disposed in dispense head 208 at angles relative to the vertical or Z-axis. During operation, once fluid has been removed from a multi-well container, dispense head 208 is optionally utilized to fill selected wells in the plate, e.g., with a cleaning fluid, reagent, or the like. Dispense tips 224 are angled so that fluid is dispensed onto the sides of the selected wells to ensure that non-removed material (e.g., cells, etc.) disposed on the bottom of the selected wells is not disturbed when fluids are dispensed. Optionally, dispense tips are disposed substantially parallel, e.g., with the Z-axis. This is illustrated, for example, in dispense head 210. In some embodiments, the dispensing component is structured to dispense the materials to a plurality of multi-well containers substantially simultaneously. Dispensing components for dispensing fluids to multiple multi-well containers, which are optionally adapted for use in the systems of the present invention are described further in, e.g., International Publication No. WO 02/076830, entitled “MASSIVELY PARALLEL FLUID DISPENSING SYSTEMS AND METHODS,” filed Mar. 27, 2002 by Downs et al., which is incorporated by reference.

As also shown in FIG. 2A, multi-well container processing system 200 includes positioning component 226, which precisely positions multi-well containers relative to fluid removal head 100 and dispense heads 208 and 210 so that materials can be removed from and/or dispensed into selected wells of a multi-well container. Positioning component 226 is mounted on X-axis translocation component 228, which moves (e.g., slides) positioning component 226 along the X-axis to align wells disposed in multi-well containers with tip inlets to fluid removal head 100 and dispense tips of dispense heads 208 and 210. A drive mechanism (not shown), such as a servo motor, a stepper motor, or the like, is generally operably connected to X-axis translocation component 228 to effect movement of positioning component 226 and/or other components. Typically, the positioning components of the invention includes appropriate mounting/alignment structural elements, such as alignment pins and/or holes, nesting wells, or the like, e.g., to facilitate proper alignment of multi-well containers with system components. Additional details relating to positioning components that can be utilized in the systems of the invention are described in, e.g., International Publication No. WO 01/96880, entitled “AUTOMATED PRECISION OBJECT HOLDER,” filed Jun. 15, 2001 by Mainquist et al., which is incorporated by reference.

Multi-well container processing system 200 also includes cleaning or washing component 230, which is structured to wash or otherwise clean fluid removal head 100 and dispense tips of dispense heads 208 and 210. Washing component 230 is also mounted on X-axis translocation component 228 (e.g., a multi-well container moving component, etc.). In addition to moving positioning component 226, translocation component 228 also moves (e.g., slides) washing component 230 along the X-axis to align fluid removal head 100 and dispense tips of dispense heads 208 and 210 with components of washing component 230. More particularly, washing component 230 includes recirculation bath or trough 232 into which translocation component 202 lowers fluid removal head 100 for cleaning, e.g., after materials have been removed from a multi-well container positioned on positioning component 226. In addition, washing component 230 also includes vacuum ports 234 and 236 into which dispense tips of dispense heads 208 and 210 are lowered, respectively, by translocation component 202 to remove, e.g., fluid or other materials adhered to external surfaces of the dispense tips.

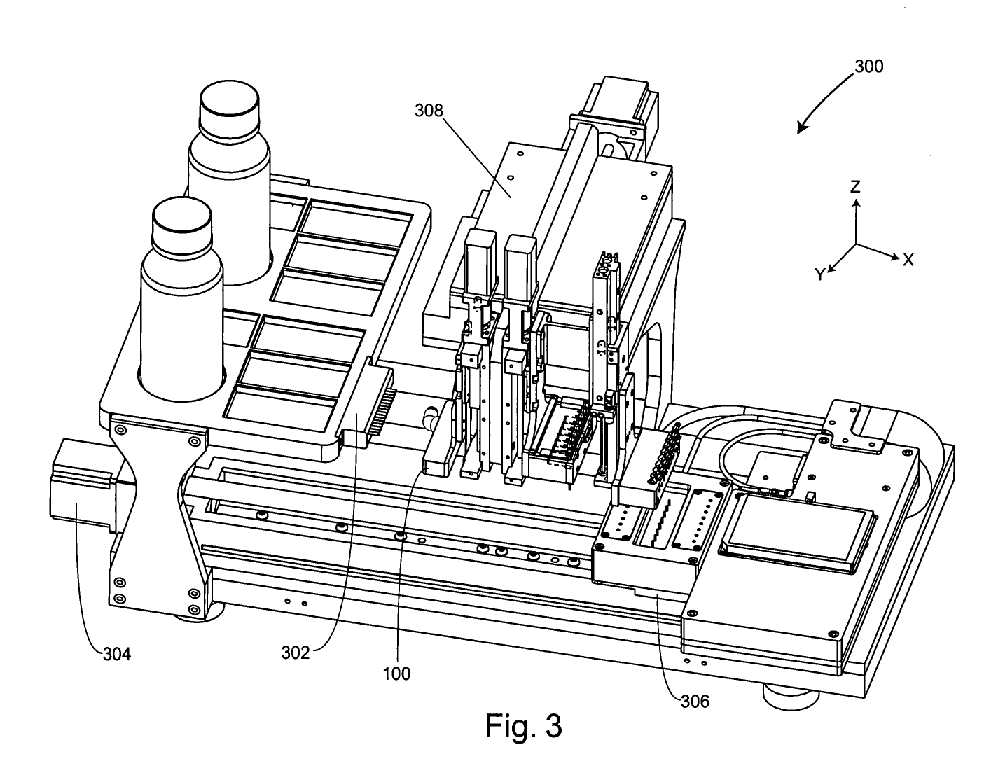

FIG. 3 schematically illustrates another exemplary embodiment of a multi-well container processing system of the present invention. As shown, multi-well container processing system 300 includes fluid removal head 100 mounted on Y- and Z-axis translocation component 308. Although not shown in FIG. 3, tubes or other conduits operably connect fluid removal head 100 to a negative pressure source via manifold 302. In some embodiments, for example, a single tube connects the negative pressure source to manifold 302, while multiple tubes connect manifold 302 to the outlets of fluid removal head 100. Manifolds are optionally separate components from fluid removal heads, such as manifold 302, or fabricated integral with fluid removal heads. The tubes or other conduits have cross-sectional dimensions that are large enough not to restrict vacuum flow from the negative pressure source. At least one valve (e.g., a solenoid valve, etc.) that is structured to regulate pressure flow from the negative pressure source is generally operably connected to fluid removal head 100, manifold 302, and/or the tubes. Other aspects of multi-well container processing system 300 are the same or similar to those described above with respect to multi-well container processing system 200 with certain exceptions. For example, dispense heads 208 and 210 are both included as components of dispensing component 204, with fluid removal head 100 being included as a component of dispensing component 206. In the system schematically illustrated in FIG. 2A, fluid removal head 100 is included as a component of dispensing component 204. In addition, manifolds 216 and 218, which are illustrated in FIG. 2A, are also optionally adapted for use with multi-well container processing system 300. Furthermore, drive mechanism 304 (e.g., a servo motor, stepper motor, etc.), which is operably connected to X-axis translocation component 306 to effect movement of X-axis translocation component 306 is also typically included in multi-well container processing system 200 to similarly effect movement of X-axis translocation component 228.

The systems of the invention optionally further include various incubation components and/or multi-well container storage components. In some embodiments, for example, systems include incubation components that are structured to incubate or regulate temperatures within multi-well containers. To illustrate, many cell-based or other types of assays include incubation steps and can be performed using these systems. Additional details regarding incubation devices that are optionally adapted for use with the systems of the present invention are described in, e.g., International Publication No. WO 03/008103, entitled “HIGH THROUGHPUT INCUBATION DEVICES,” published Jan. 30, 2003 by Weselak et al., which is incorporated by reference. In certain embodiments, multi-well container processing systems of the invention include multi-well container storage components that are structured to store one or more multi-well containers. Such storage components typically include multi-well container hotels or carousels that are known in the art and readily available from various commercial suppliers, such as Beckman Coulter, Inc. (Fullerton, Calif.). For example, in one embodiment, a multi-well container processing system of the invention includes a stand-alone station in which a user loads a number of multi-well containers to be washed or otherwise processed into one or more storage components of the system for automated processing of the plates. In these embodiments, the systems of the invention also typically include one or more robotic gripper apparatus that move plates, e.g., between incubation or storage components and positioning components. Robotic grippers that are suitable for use in the systems of the invention are described further below or otherwise known in the art. For example, a TECAN® robot, which is commercially available from Clontech (Palo Alto, Calif., USA), is optionally adapted for use in the systems described herein.

In certain embodiments, the systems of the invention also include at least one detection component that is structured to detect detectable signals produced, e.g., in wells of multi-well containers. Suitable signal detectors that are optionally utilized in these systems detect, e.g., fluorescence, phosphorescence, radioactivity, mass, concentration, pH, charge, absorbance, refractive index, luminescence, temperature, magnetism, or the like. Detectors optionally monitor one or a plurality of signals from upstream and/or downstream of the performance of, e.g., a given assay step. For example, the detector optionally monitors a plurality of optical signals, which correspond in position to “real time” results. Example detectors or sensors include photomultiplier tubes, CCD arrays, optical sensors, temperature sensors, pressure sensors, pH sensors, conductivity sensors, scanning detectors, or the like. Each of these as well as other types of sensors is optionally readily incorporated into the systems described herein. The detector optionally moves relative to multi-well containers or other assay components, or alternatively, multi-well containers or other assay components move relative to the detector. In certain embodiments, for example, detection components are coupled to translation components that move the detection components relative to multi-well containers positioned on positioning components of the systems described herein. Optionally, the systems of the present invention include multiple detectors. In these systems, such detectors are typically placed either in or adjacent to, e.g., a multi-well container or other vessel, such that the detector is within sensory communication with the multi-well container or other vessel (i.e., the detector is capable of detecting the property of the plate or vessel or portion thereof, the contents of a portion of the plate or vessel, or the like, for which that detector is intended).

The detector optionally includes or is operably linked to a computer, e.g., which has system software for converting detector signal information into assay result information or the like. For example, detectors optionally exist as separate units, or are integrated with controllers into a single instrument. Integration of these functions into a single unit facilitates connection of these instruments with the computer, by permitting the use of few or a single communication port(s) for transmitting information between system components. Computers and controllers are described further below. Detection components that are optionally included in the systems of the invention are described further in, e.g., Skoog et al., Principles of Instrumental Analysis, 5^{th} Ed., Harcourt Brace College Publishers (1998) and Currell, Analytical Instrumentation: Performance Characteristics and Quality, John Wiley & Sons, Inc. (2000), which are incorporated by reference in their entirety for all purposes.

The systems of the invention optionally also include at least one robotic gripping component that is structured to grip and translocate multi-well containers between components of the multi-well container processing systems and/or between the multi-well container processing systems and other locations (e.g., other work stations, etc.). In certain embodiments, for example, systems further include gripping components that move multi-well containers between positioning components, incubation components, and/or detection components. A variety of available robotic elements (robotic arms, movable platforms, etc.) can be used or modified for use with these systems, which robotic elements are typically operably connected to controllers that control their movement and other functions. Exemplary robotic gripping devices that are optionally adapted for use in the systems of the invention are described further in, e.g., U.S. Pat. No. 6,592,324, entitled “GRIPPER MECHANISM,” issued Jul. 15, 2003 to Downs et al. and International Publication No. WO 02/068157, entitled “GRIPPING MECHANISMS, APPARATUS, AND METHODS,” published Sep. 6, 2002 by Downs et al., which are both incorporated by reference.

The multi-well container processing systems of the invention also typically include controllers that are operably connected to one or more components (e.g., solenoid valves, pumps, translocation components, positioning components, etc.) of the system to control operation of the components. More specifically, controllers are generally included either as separate or integral system components that are utilized, e.g., to regulate the pressure applied by negative pressure sources at fluid removal head tip inlets, the quantities of samples, reagents, cleaning fluids, or the like dispensed from dispense heads, the movement of translocation components, e.g., when positioning multi-well containers relative to fluid removal or dispense heads, etc. Controllers and/or other system components is/are optionally coupled to an appropriately programmed processor, computer, digital device, or other information appliance (e.g., including an analog to digital or digital to analog converter as needed), which functions to instruct the operation of these instruments in accordance with preprogrammed or user input instructions, receive data and information from these instruments, and interpret, manipulate and report this information to the user.

Any controller or computer optionally includes a monitor that is often a cathode ray tube (“CRT”) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation, e.g., varying or selecting the rate or mode of movement of various system components, directing translation of robotic gripping apparatus, fluid removal heads, fluid dispensing heads, or of one or more multi-well containers or other vessels, or the like. The computer then receives the data from, e.g., sensors/detectors included within the system, and interprets the data, either provides it in a user understood format, or uses that data to initiate further controller instructions, in accordance with the programming, e.g., such as in monitoring incubation temperatures, detectable signal intensity, or the like. More specifically, the software utilized to control the operation of the systems described herein typically includes logic instructions, e.g., that direct translocation components to lower the tips of fluid removal heads to a first position in the wells of multi-well containers, and that direct negative pressure sources to apply a first negative pressure to the tips as the tips are lowered and/or once the tips are at the first position in the wells. In addition, this software also generally includes logic instructions, e.g., that direct translocation components to raise the tips, after selected volumes of fluid have been removed from wells, to a second position in the wells or proximal to the openings to the wells, and that direct the negative pressure sources to apply a second negative pressure to the tips that is greater than the first negative pressure such that air is drawn through the vent openings to effect removal of adherent fluid from the tips and from the sides of the wells.

The computer can be, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX-based machine, a MACINTOSH™, Power PC, or a UNIX-based (e.g., SUN™ work station) machine) or other common commercially available computer that is known to one of skill. Standard desktop applications such as word processing software (e.g., Microsoft Word™ or Corel WordPerfect™) and database software (e.g., spreadsheet software such as Microsoft Excel™, Corel Quattro Pro™, or database programs such as Microsoft Access™ or Paradox™) can be adapted to the present invention. Software for performing, e.g., fluid removal from selected wells of a multi-well container is optionally constructed by one of skill using a standard programming language such as AppleScript, Visual basic, Fortran, Basic, Java, or the like.

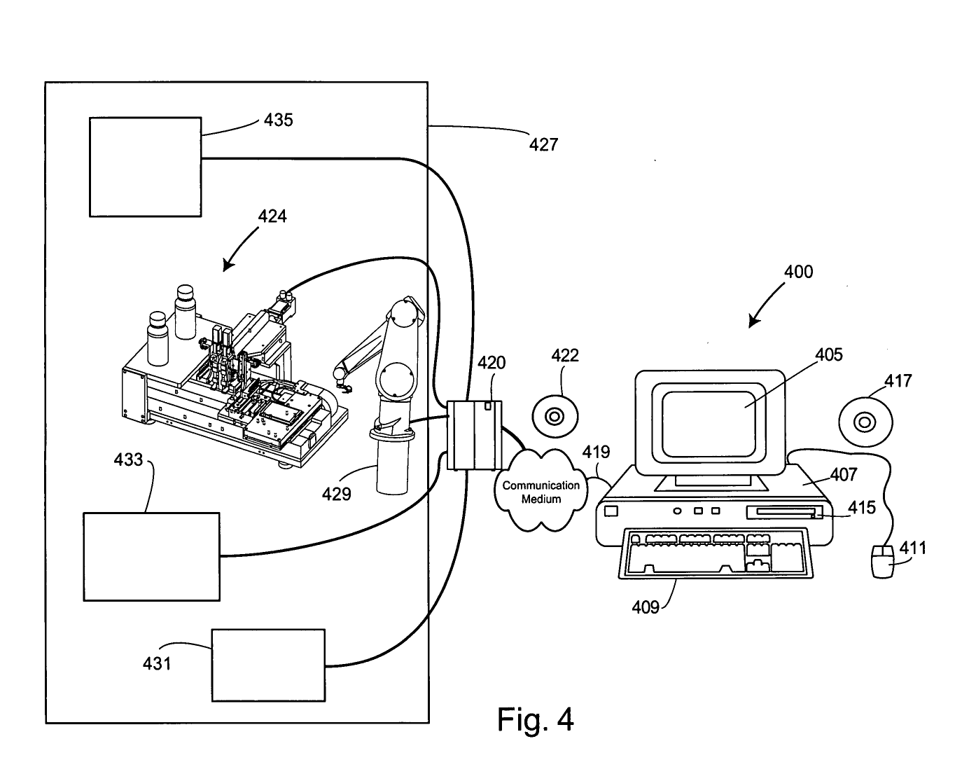

FIG. 4 is a schematic showing a representative example multi-well container processing system including an information appliance in which various aspects of the present invention may be embodied. As will be understood by practitioners in the art from the teachings provided herein, the invention is optionally implemented in hardware and software. In some embodiments, different aspects of the invention are implemented in either client-side logic or server-side logic. As will also be understood in the art, the invention or components thereof may be embodied in a media program component (e.g., a fixed media component) containing logic instructions and/or data that, when loaded into an appropriately configured computing device, cause that apparatus or system to perform according to the invention. As will additionally be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 4 shows information appliance or digital device 400 that may be understood as a logical apparatus (e.g., a computer, etc.) that can read instructions from media 417 and/or network port 419, which can optionally be connected to server 420 having fixed media 422. Information appliance 400 can thereafter use those instructions to direct server or client logic, as understood in the art, to embody aspects of the invention. One type of logical apparatus that may embody the invention is a computer system as illustrated in 400, containing CPU 407, optional input devices 409 and 411, disk drives 415 and optional monitor 405. Fixed media 417, or fixed media 422 over port 419, may be used to program such a system and may represent a disk-type optical or magnetic media, magnetic tape, solid state dynamic or static memory, or the like. In specific embodiments, the aspects of the invention may be embodied in whole or in part as software recorded on this fixed media. Communication port 419 may also be used to initially receive instructions that are used to program such a system and may represent any type of communication connection. Optionally, aspects of the invention are embodied in whole or in part within the circuitry of an application specific integrated circuit (ACIS) or a programmable logic device (PLD). In such a case, aspects of the invention may be embodied in a computer understandable descriptor language, which may be used to create an ASIC, or PLD. FIG. 4 also includes multi-well container processing system 427, which includes fluid removal station 424, robotic gripping component 429, incubation component 431, multi-well container storage component 433, and detection component 435. These system components are typically operably connected to information appliance 400 directly or via server 420. During operation, fluid removal station 424 typically removes fluids from selected wells of multi-well containers positioned on a positioning component of fluid removal station 424, e.g., as part of a process to clean the containers, and robotic gripping component 429 moves the containers between the components of multi-well container processing system 427.

IV. Methods of Removing Fluid From Multi-Well Containers

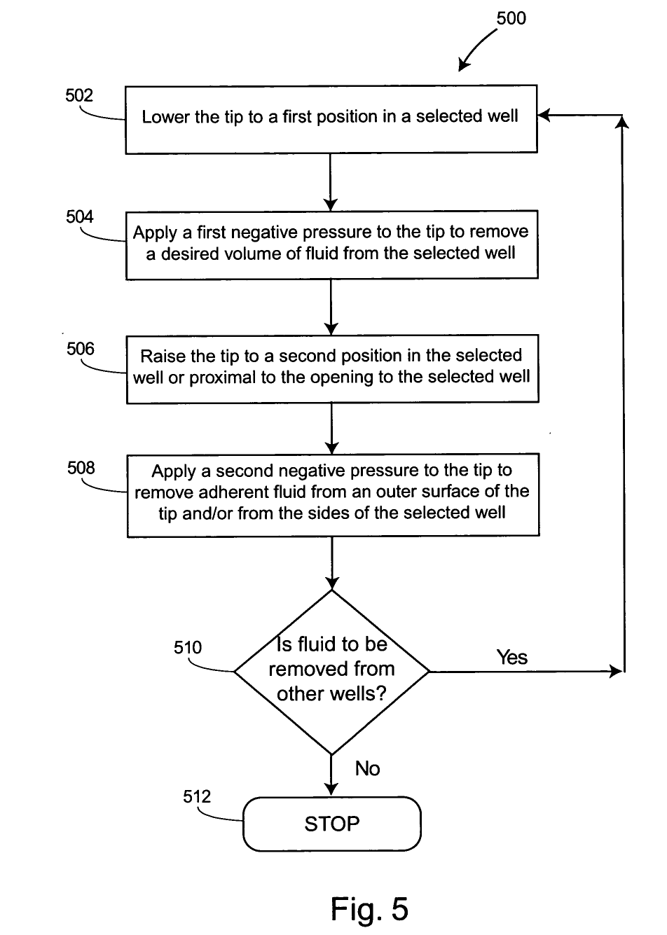

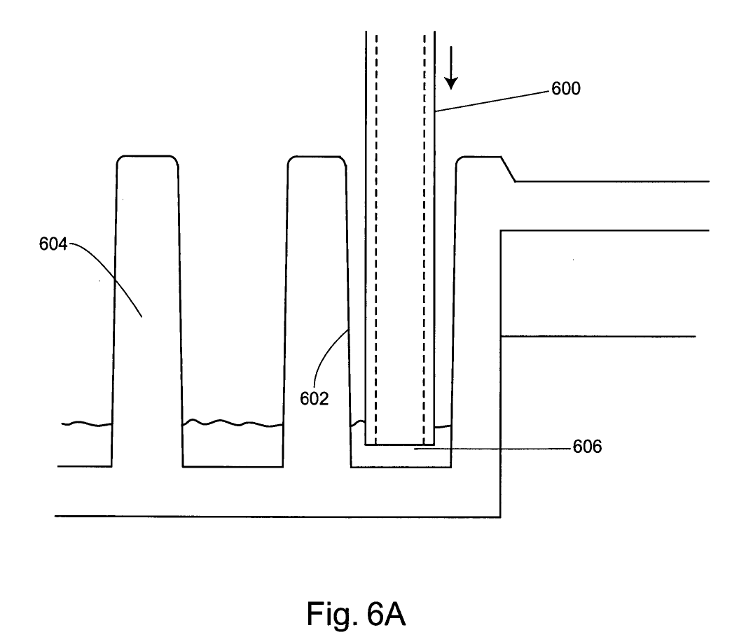

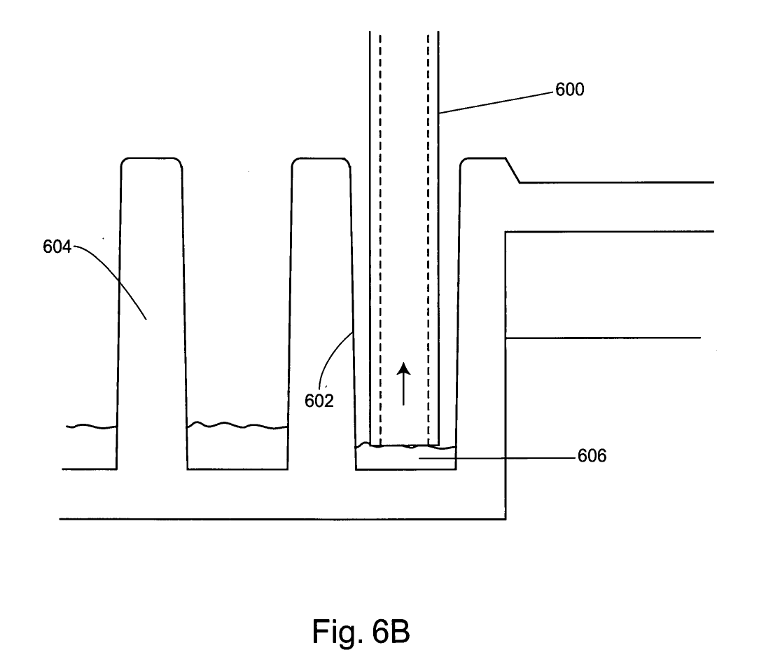

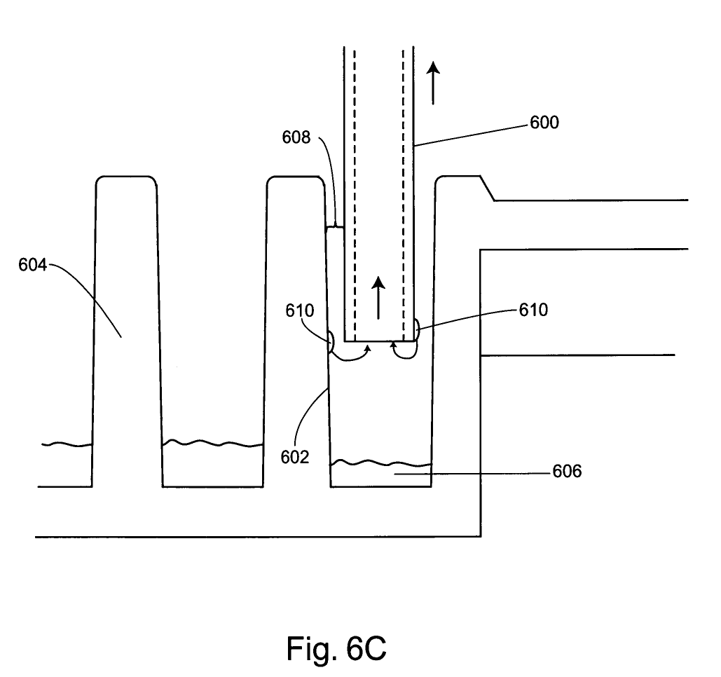

The present invention also provides methods of removing fluid from multi-well containers. The methods include providing at least one tip, e.g., as part of a fluid removal system described herein (e.g., a stand-alone work station, an automated screening system, etc.). To illustrate, FIG. 5 is a flowchart showing method 500 of removing fluid from a multi-well container that uses such a tip according to one embodiment of the invention. As shown, step 502 includes lowering the tip to a first position in a selected well of the multi-well container. The first position is typically below a surface of fluid disposed in the selected well. As shown in step 504, method 500 also includes applying a first negative pressure to the tip to remove a desired volume of fluid from the selected well. The first negative pressure is applied while the tip is lowered and/or after the tip has reached the first position in the selected well. In some embodiments, a negative pressure source applies the first negative pressure at at least 28.5 inches Hg at a flow rate of at least 0.1 cubic feet per minute at the tip inlet during this process. When negative pressure is applied as the tip is lowered, the tip is generally lowered at a rate that is faster than the fluid is removed from the well by the negative pressure. Optionally, at least one other material (e.g., residual fluid, cellular material or another non-fluidic material, etc.) is selectively not removed from the well. This selectivity is particularly advantageous when performing cell-based assays (e.g., cell-based ELISA assays, etc.) using the multi-well container format, as it is typically desirable to retain cells in the wells, e.g., during various wash steps. The methods of the present invention significantly increase the throughput achievable for these and other screening assays relative to those performed using pre-existing methods.

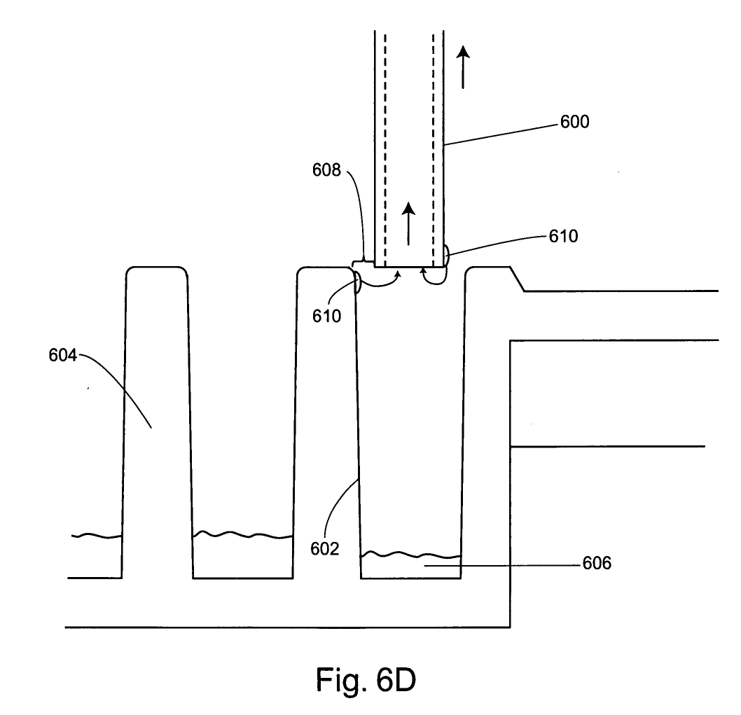

To further illustrate aspects of these steps of method 500, FIG. 6A schematically shows tip 600 lowered to a first position in selected well 602 of multi-well container 604. As shown, tip 600 is below the surface of fluid 606 in selected well 602 before the desired volume of fluid 606 is removed from selected well 602. FIG. 6B schematically illustrates the desired volume of fluid 606 being removed from selected well 602. As mentioned above, this volume can be removed as tip 600 is lowered to the first position and/or after tip 600 has reached this position in selected well 602.

Method 500 includes raising the tip to a second position in the selected well or proximal to the opening to the selected well after the desired volume of fluid is removed from the selected well (step 506). The second position is generally above the surface of residual fluid in the selected well. In step 508, method 500 includes applying a second negative pressure to the tip to draw air through the vent opening to effect removal of adherent fluid from an outer surface of the tip and/or from the sides of the selected well. The removal of adherent fluid from the tip during this step reduces or eliminates cross-contamination among wells in the multi-well container when fluids are removed from multiple wells in the container with the tip. The second negative pressure is typically greater than the first negative pressure and is generally strong enough to remove the fluid, but gentle enough as to not disturb, e.g., residual fluid, cells, etc. at the bottom of the well. In some embodiments, for example, the second negative pressure is applied at a flow rate at the tip inlet that is at least 5 times more than the flow rate of the first negative pressure at the tip inlet. For example, the second negative pressure is applied at a flow rate of 0.5 or more cubic feet per minute at the tip inlet in certain embodiments. To further illustrate aspects of these steps of method 500, FIG. 6C schematically shows tip 600 raised to a second position that is in selected well 602, whereas FIG. 6D schematically depicts tip 600 raised to a second position that is proximal to the opening to selected well 602. As further shown, when the second negative pressure is applied, air is drawn through vent opening 608 such that adherent fluid 610 is removed from an outer surface of tip 600 and from the sides of selected well 602.

If fluid is to be removed from other wells, then as shown in step 510, method 500 includes lowering the tip into those wells (i.e., the method continues by feeding back to step 502). If no material is to be removed from other wells, then as shown in step 510, method 500 stops (step 512). Although not shown, additional steps, such as dispensing steps, multi-well container translocation steps, and/or fluid removal head washing steps are optionally performed before or after selected steps in this method. In some embodiments, the method further includes detecting detectable signals produced in one or more wells using a detector.

In another embodiment, the fluid removal head is designed to move across a multi-well container cleaning out, e.g., 32 wells at a time. An exemplary fluid removal head of this type is schematically depicted in FIG. 1 and is further described in the related description provided above. This process typically begins by aligning the tips of the fluid removal head over the first group of wells to be aspirated. The wash head is lowered so that the tips reach a selected level or first position in the wells to be aspirated. Vacuum is applied to the tip inlets as the tips are lowered and/or after they reach the selected level in the wells to remove fluid from the wells. A solenoid valve is typically opened to activate the vacuum line. After selected volumes of fluid have been removed from the wells, the fluid removal head is raised to a higher position in the wells or proximal to the openings to the wells. Vacuum is then applied to the tip inlets at a rate sufficient to remove any adherent fluid from the surfaces of the tips and the sides of the wells without disturbing residual fluid or other materials disposed at the bottom of the wells.

When fluid has been removed from the wells and the tips have been cleaned in this manner, the solenoid valve turns off the vacuum flow from the negative pressure source. The fluid removal head or washer is then moved to the next column on the 1536 well plate. Once in place, the process described above is repeated. The washer moves across the plate following this process. The washer can also be run with the vacuum on constantly. This allows for much faster cycle times.

Once fluid has been removed from the multi-well container, a dispense head typically fills each well with a cleaning fluid. The tips on this dispenser are typically angled so that fluid is dispensed onto the side of each selected well. This ensures that any material (e.g., cells, etc.) on the bottom of each well is not disturbed. The cleaning fluid will then typically be removed following the method described above. Washing is then optionally repeated or the plate can move on to the next step in an assay.

In some embodiments, fluids can be dispensed into wells through the inlets of the fluid removal head. For example, the outlets can be connected to a valve that, in one position, is operably connected to the negative pressure source and therefore draws materials out of the wells. When the valve is switched to a second position, an operable connection is formed between the tips of the fluid removal head and a reservoir that contains a fluid that is to be dispensed into the wells. By cycling the valve one or more times, one can quickly perform several cycles of wash and removal.

V. Fluid Removal Kits

The present invention also provides kits that include at least one fluid removal head or components thereof. For example, a kit typically includes body structures, tips, resilient couplings (e.g., springs, formed elastomeric materials, etc.), and/or fastening components (e.g., screws, bolts, or the like) to assemble head components and/or to attach fluid removal heads to other system components. The fluid removal heads of the kits of the invention are optionally pre-assembled (e.g., include components that are integral with one another, etc.) or unassembled. In addition, kits typically further include appropriate instructions for assembling, utilizing, and maintaining the fluid removal heads or components thereof. Kits also typically include packaging materials or containers for holding kit components.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication,.patent, patent application, and/or other document were individually indicated to be incorporated by reference for all purposes.

What is claimed is:

1. A fluid removal head, comprising at least one tip that comprises at least one inlet and at least one outlet, which inlet communicates with the outlet, wherein the tip is structured such that:
when the tip is disposed in, or proximal to an opening to, a selected well of a multi-well container, a space disposed between an outer surface of the tip and sides of, and/or an opening to, the well forms a vent opening; and
when the tip is positioned above a surface of residual fluid disposed in the well and a selected negative pressure is applied to the tip, the applied negative pressure draws air through the vent opening resulting in removal of adherent fluid from the tip and from the sides of the well.

2. The fluid removal head of claim 1, wherein the inlet and the outlet communicate with each other via at least one channel disposed through the tip, which channel comprises a cross-sectional dimension of 50 μm or more.

3. The fluid removal head of claim 1, wherein when the tip is disposed in, or proximal to the opening to, the well, the space disposed between the outer surface of the tip and the sides of, and/or the opening to, the well comprises a distance of 1 mm or less.

4. The fluid removal head of claim 1, wherein the tip comprises a cross-sectional shape selected from the group consisting of: a regular n-sided polygon, an irregular n-sided polygon, a triangle, a square, a rectangle, a trapezoid, a circle, and an oval.

5. The fluid removal head of claim 1, comprising at least one body structure, wherein a resilient coupling couples the tip to the body structure.

6. The fluid removal head of claim 1, comprising at least one body structure that comprises at least one manifold.

7. The fluid removal head of claim 1, wherein the fluid removal head is structured to remove fluids from a plurality of multi-well containers substantially simultaneously.

8. The fluid removal head of claim 1, comprising at least one body structure that comprises at least one cavity, wherein the tip extends 0.1 mm or more into the cavity.

9. The fluid removal head of claim 8, wherein the body structure comprises at least one tip holder and at least one port mount that are coupled together to form the cavity, which tip holder holds the tip and which port mount comprises at least one port having a channel disposed therethrough, which channel communicates with the cavity.

10. The fluid removal head of claim 9, wherein the tip and/or port mount is fabricated from an alloy or a metallic substance and the tip holder is fabricated from a polymeric substance.

11. The fluid removal head of claim 9, wherein surfaces of the cavity and the channel are substantially smooth.

12. The fluid removal head of claim 9, wherein at least one surface of the body structure that forms at least a portion of the cavity is angled toward the channel.

13. The fluid removal head of claim 1, wherein the fluid removal head comprises at least two tips that are spaced at a distance that substantially corresponds to a distance between at least two wells disposed in a multi-well container.

14. The fluid removal head of claim 13, wherein the tips are structured to remove fluids from multi-well containers that comprise 6, 12, 24, 48, 96, 192, 384, 768, 1536, or more wells.

15. A multi-well container processing system, comprising:
a) at least one tip that comprises at least one inlet and at least one outlet, which inlet communicates with the outlet, wherein the tip is structured such that when the tip is disposed in a selected well of a multi-well container, a space disposed between an outer surface of the tip and sides of, and/or an opening to, the well forms a vent opening;
b) at least one negative pressure source operably connected to the outlet of the tip; and,
c) at least one controller operably connected to the processing system, which controller is configured to effect:
i) lowering the tip to a first position in the well, which first position is below a surface of fluid in the well, while applying a first negative pressure to the tip, wherein the tip is lowered at a rate that is faster than the fluid is removed from the well by the negative pressure, and/or lowering the tip to the first position in the well and then apply the first negative pressure to the tip;
ii) raising the tip to a second position in the well or proximal to the opening to the well, which second position is above the surface of residual fluid in the well; and
iii) applying a second negative pressure to the tip, which second negative pressure is greater than the first negative pressure, wherein the application of the second negative pressure draws air through the vent opening resulting in removal of adherent fluid from the tip and from the sides of the well.

16. The multi-well container processing system of claim 15, wherein the inlet and the outlet communicate with each other via at least one channel disposed through the tip, which channel comprises a cross-sectional dimension of 50 μm or more.

17. The multi-well container processing system of claim 15, wherein when the tip is disposed in, or proximal to the opening to, the well, the space disposed between the outer surface of the tip and the sides of, and/or the opening to, the well comprises a distance of 1 mm or less.

18. The multi-well container processing system of claim 15, wherein the tip comprises a cross-sectional shape selected from the group consisting of: a regular n-sided polygon, an irregular n-sided polygon, a triangle, a square, a rectangle, a trapezoid, a circle, and an oval.

19. The multi-well container processing system of claim 15, wherein the negative pressure source comprises at least one manifold.

20. The multi-well container processing system of claim 15, wherein at least one tube operably connects the negative pressure source to the outlet.

21. The multi-well container processing system of claim 15, wherein the negative pressure source comprises a pump.

22. The multi-well container processing system of claim 15, wherein the negative pressure source is configured to apply the first negative pressure at at least 28.5 inches Hg at a flow rate of at least 0.1 cubic feet per minute at each inlet.

23. The multi-well container processing system of claim 15, wherein the negative pressure source is configured to apply the second negative pressure at a flow rate at each inlet that is at least 5 times more than the flow rate of the first negative pressure at each inlet.

24. The multi-well container processing system of claim 15, wherein the controller comprises at least one computer.

25. The multi-well container processing system of claim 15, comprising at least one trap that is operably connected to the tip, which trap is structured to trap waste fluid that is removed from wells of a multi-well container.

26. The multi-well container processing system of claim 15, comprising at least one robotic gripping component that is structured to grip and translocate multi-well containers between components of the multi-well container processing system and/or between the multi-well container processing system and another location.

27. The multi-well container processing system of claim 15, comprising at least one multi-well container storage component that is structured to store one or more multi-well containers.

28. The multi-well container processing system of claim 15, comprising at least one incubation component that is structured to incubate one or more multi-well containers.

29. The multi-well container processing system of claim 15, comprising at least one detection component that is structured to detect detectable signals produced in one or more wells disposed in one or more multi-well containers.

30. The multi-well container processing system of claim 15, comprising at least one positioning component that is structured to position one or more multi-well containers relative to the tip.

31. The multi-well container processing system of claim 15, comprising at least one translocation component that is structured to translocate the tip and/or at least one other system component relative to one another.

32. The multi-well container processing system of claim 15, comprising at least one cleaning component that is structured to clean the tip and/or at least one other system component.

33. The multi-well container processing system of claim 15, comprising at least one valve fluidly communicates with the tip, which valve is structured to regulate pressure flow from the negative pressure source.

34. The multi-well container processing system of claim 33, wherein the valve comprises a solenoid valve.

35. The multi-well container processing system of claim 15, wherein a fluid removal head comprises the tip.

36. The multi-well container processing system of claim 35, wherein the fluid removal head comprises at least one body structure, and wherein a resilient coupling couples the tip to the body structure.

37. The multi-well container processing system of claim 35, wherein the fluid removal head comprises at least one body structure that comprises at least one manifold.

38. The multi-well container processing system of claim 35, wherein the fluid removal head comprises at least one body structure that comprises at least one cavity, wherein the tip extends 0.1 mm or more into the cavity.

39. The multi-well container processing system of claim 35, wherein the fluid removal head is structured to remove fluids from a plurality of multi-well containers substantially simultaneously.

40. The multi-well container processing system of claim 35, wherein the fluid removal head comprises at least two tips that are spaced to simultaneously fit within a single well of a multi-well container.

41. The multi-well container processing system of claim 35, wherein the fluid removal head comprises at least two tips that are spaced at a distance that substantially corresponds to a distance between at least two wells disposed in a multi-well container.

42. The multi-well container processing system of claim 41, wherein the tips are structured to remove fluids from multi-well containers that comprise 6, 12, 24, 48, 96, 192, 384, 768, 1536, or more wells.

43. The multi-well container processing system of claim 15, comprising at least one dispensing component that is structured to dispense one or more fluids into one or more wells of one or more multi-well containers.

44. The multi-well container processing system of claim 43, wherein the dispensing component is structured to dispense the fluids into a plurality of multi-well containers substantially simultaneously.

45. The multi-well container processing system of claim 43, wherein the dispensing component comprises at least one dispenser that aligns with one or more wells disposed in one or more multi-well containers when the multi-well containers are disposed proximal to the dispenser, which dispenser is structured to dispense one or more fluids into the wells.

46. The multi-well container processing system of claim 45, wherein the dispenser is angled relative to a vertical axis of the wells.

47. A method of removing fluid from a well of multi-well container, the method comprising:
a) providing at least one tip that comprises at least one inlet and at least one outlet, which inlet communicates with the outlet, wherein the tip has a cross-sectional dimension that is smaller that a cross-sectional dimension of the well thereby forming a vent opening in a space disposed between the tip and sides of, and/or an opening to, the well when the tip is positioned in the well or proximal to the opening to the well;
b) lowering the tip to a first position in the well, which first position is below a surface of the fluid, while applying a first negative pressure to the tip, wherein the tip is lowered at a rate that is faster than the fluid is removed from the well by the negative pressure, or lowering the tip to the first position in the well and then applying the first negative pressure to the tip;
c) raising the tip to a second position in the well or proximal to the opening to the well, which second position is above the surface of residual fluid in the well; and,
d) applying a second negative pressure to the tip, which second negative pressure is greater than the first negative pressure, wherein the application of the second negative pressure draws air through the vent opening resulting in removal of adherent fluid from an outer surface of the tip and from the sides of the well.

48. The method of claim 47, wherein the first negative pressure comprises a flow rate of 0.1 or more cubic feet per minute at the inlet.

49. The method of claim 47, wherein the second negative pressure comprises a flow rate of 0.5 or more cubic feet per minute at the inlet.

50. The method of claim 47, wherein the second negative pressure comprises a flow rate at the inlet that is at least 5 times more than the flow rate of the first negative pressure at the inlet.

51. The method of claim 47, comprising repeating b)-d) in at least one other well of the multi-well container.

52. The method of claim 47, comprising dispensing at least one additional fluid into the well.

53. The method of claim 52, wherein the additional fluid contacts a side of the well before contacting a bottom surface of the well or other materials disposed in the well to minimize agitation of the other materials by the additional fluid dispensed into the first well.

54. The method of claim 52, wherein the additional fluid comprises a cleaning solvent.
